(19) United States
(12) Patent Application Publication
(10) Pub. No.: US 2021/0019807 A1
(43) Pub. Date: Jan. 21, 2021

(54) SYSTEM AND METHOD FOR A GIFT REGISTRY

(71) Applicant: Jessica Romo, Petaluma, CA (US)

(72) Inventor: Jessica Romo, Petaluma, CA (US)

(21) Appl. No.: 16/923,982

(22) Filed: Jul. 8, 2020

Related U.S. Application Data
(60) Provisional application No. 62/874,368, filed on Jul. 15, 2019.

(51) Int. Cl. G06Q 30/06

(52) U.S. Cl. CPC G06Q 30/0633; G06Q 30/0603; G06Q 30/0643; G06Q 30/0631; G06Q 30/0625

(57) ABSTRACT

A gift application enables users to create personal gift registries and wish lists, and organizes the lists into one convenient location. The invention is comprised of a mobile application that enables users to register and create their lists or compile their lists from various other websites. Users may make accounts for other individuals, such as children, grandparents, etc. Users can add a photo of the recipient and can add a co-host to the account that can edit the list. Individuals can then search the name of the person they would like to buy a gift for in order to pull up that person's registry/list. The app is designed to provide a link for each item listed so that the item can be easily purchased. The application will also have the capability to label items as already purchased so that duplicate gifts are not an issue.

### CROSS-REFERENCE TO RELATED APPLICATIONS

The present application claims priority to provisional application Ser. No. 62/874,368, filed on Jul. 15, 2019 entitled “The Gift App”, the disclosure of which is hereby incorporated in its entirety at least by reference.

### BACKGROUND OF THE INVENTION

### 1. Field of the Invention

The present invention relates generally to gift giving but more particularly to a system and method for a gift registry.

### 2. Description of Related Art

Selecting a gift for a friend, loved one, co-worker, etc. can be stressful. People worry that they may not pick a desirable gift or they may buy something that the recipient already owns. Getting a gift from others is exciting, however it can be a hassle to return a gift you don't need or want. There are many emotions involved in buying and receiving gifts and sometimes it is difficult to get through the process and achieve a desirable outcome for everyone. Consequently, a suitable solution is desired.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide a gift registry system and method enabling individuals the opportunity to create a personal registry of items they would like to receive. The system offers an easy way for friends and loved ones to select the right gift for another. Effectively, the registry system eliminates the hassle of having to return a gift that is not desired. An advantage of the system is that it acts to prevent individuals from ending up with two of the same gifts, and ensures that individuals are always to pick a desirable gift for another.

In order to do so, a method is provided, comprising steps including (a) providing an Internet-connected system having one or more Internet-connected servers executing a gift registry application software from non-transitory media, the gift registry application software enabling a user to log in and create the gift registry from a smartphone; (b) an administer, via the gift registry application software, may be added, wherein the administer may create multiple accounts for additional users; (c) adding a plurality of items, via the gift registry application software, to the gift registry, wherein each item of the plurality of items includes a link to enabling the purchase of each item, and, wherein if an item of the plurality of items is purchased the item would be marked as purchase preventing the item from being purchased again; (d) creating an event, via the gift registry application software, wherein the additional users may be invented to the event; and, (e) creating a monetary fund, via the gift registry application software, wherein the monetary fund enables at least the additional users to contribute currency to the monetary fund.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a network diagram according to an embodiment of the present invention;

FIG. 2 is a flow diagram of the gift registry method according to an embodiment of the present invention; and,

FIGS. 3A-D are exemplary screen shots of the gift registry application on a computing device according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for a gift registry.

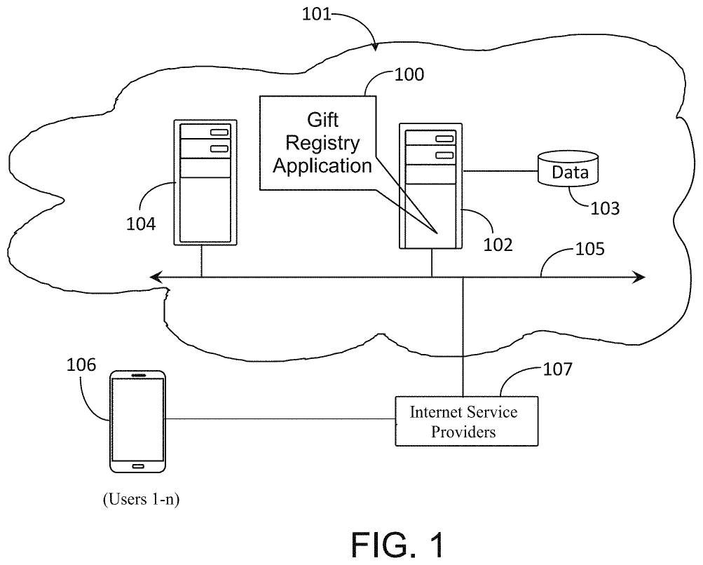

FIG. 1 is an architectural diagram of an Internet 101 computer network system according to an embodiment of the present invention. Referring now to FIG. 1, the Internet-connected system comprises one or more Internet-connected servers 102 executing gift registry application 100 software from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 are connected to the Internet-connected server via an Internet service provider (ISP) 107, allowing users 106 to access the vocational education portal. The users may use any computing device including, personal computers, laptops, tablets, and smart phones.

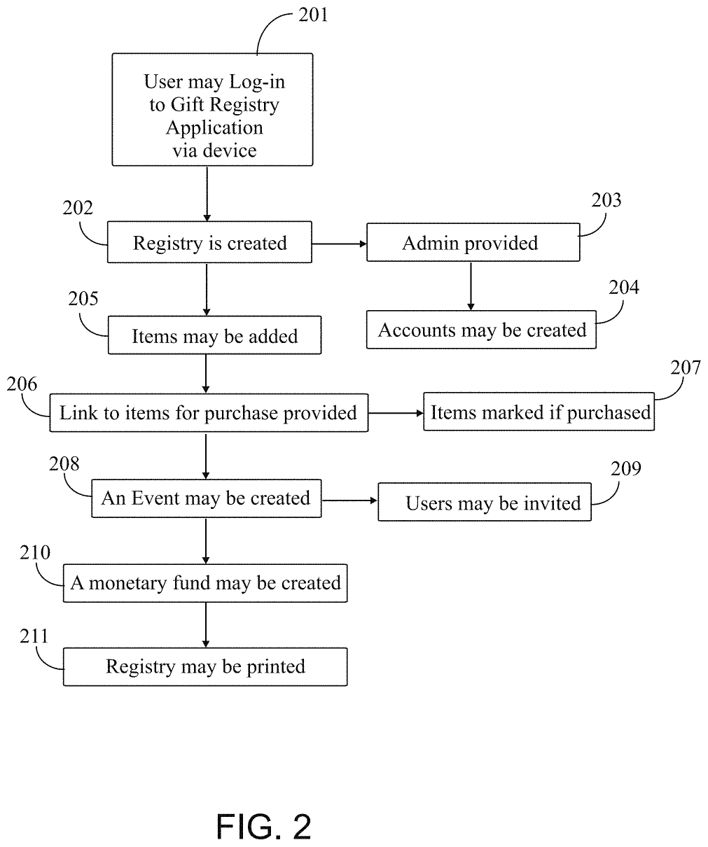

FIG. 2 is a flow diagram of the gift registry method according to an embodiment of the present invention. Referring now to FIG. 2, in step 201, a user may log-in to the gift registry application 100 via a computing device, such as a smart phone. The step includes registering for an account to create a personalized gift registry. In step 202, a registry is created, wherein the registry is attached to the account created in the previous step. In step 203, the user has the ability to select at least one administer, which generally includes the user that created the account and any other users the creator of the account desires to provide access to. In some embodiments, permissions of each administer may be customized, limiting access or control to one or more users. In step 204, the at least one administer, depending on permissions, may create accounts for additional users, via more than one registry. For example, accounts and registry lists may be created for other individuals, including but not limited to children, grandparents, spouses, friends, etc. In this way, these other individuals do not need to create their own account via the gift registry application. This is helpful for some users who are not technically savvy or old enough to use a computing device, i.e. grandparents or children. In some embodiments, photos, such as a profile photo (head shot) may be added for each user/account.

Still referring to FIG. 2, in step 205, items may be added to the registry. These items may be items of unknown location, found in brick in mortar locations, or be available for purchase online. In the event the item is available for purchase online, in step 206, a link to the item may be provided. Advantageously, this enables a user to purchase the item directly from their computing device via the link provided in regards to the item.

In some embodiments, in step 208, an event may be created. Events may be any type of event known in the art, including but not limited to birthdays, weddings, anniversaries, graduations, etc. When at least one administer creates an event, they have an opportunity to invite users to the event 209. In some embodiments, a plurality of users (friends) may be added and associated with the account, making it easy to invite one or more users of the plurality of users to the specific event, wherein the event may include an invitation to attend as well as the registry list for that specific event.

Yet still referring to FIG. 2, in step 210, a monetary fund may be created and provided the plurality of users, or other invited guests enabling the ability to contribute to the monetary fund. In some embodiments, the monetary fund is added similarly to an item on the registry giving users the ability to purchase the item or contribute to the monetary fund. Finally, in step 211 the registry may be printed if desired.

Items may be marked purchased, either manually or automatically via the system. This is advantageous, as it prevents duplicate purchases. In some embodiments, the items may be marked to intended purchase, for users you intend to purchase but will do so at a later day. In some embodiments, the “intend to purchase” will expire after a predetermined time period that may be adjusted in the settings, which is configured to prevent issues from intended purchases never being purchased. Further, the system provides notifications/alerts for both the gift giver and recipient, which may be modified as needed. It also allows the recipient to be surprised by the gifts that have been purchased. In other embodiments, if the item has been purchased, the item is removed from the registry list. Registry lists may be public or private and can only be seen by those invited to a specific event. These settings may be adjusted via in the application.

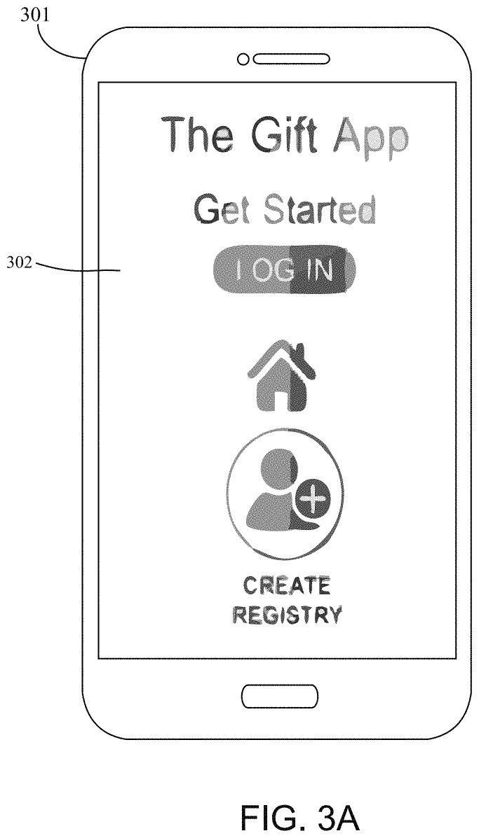

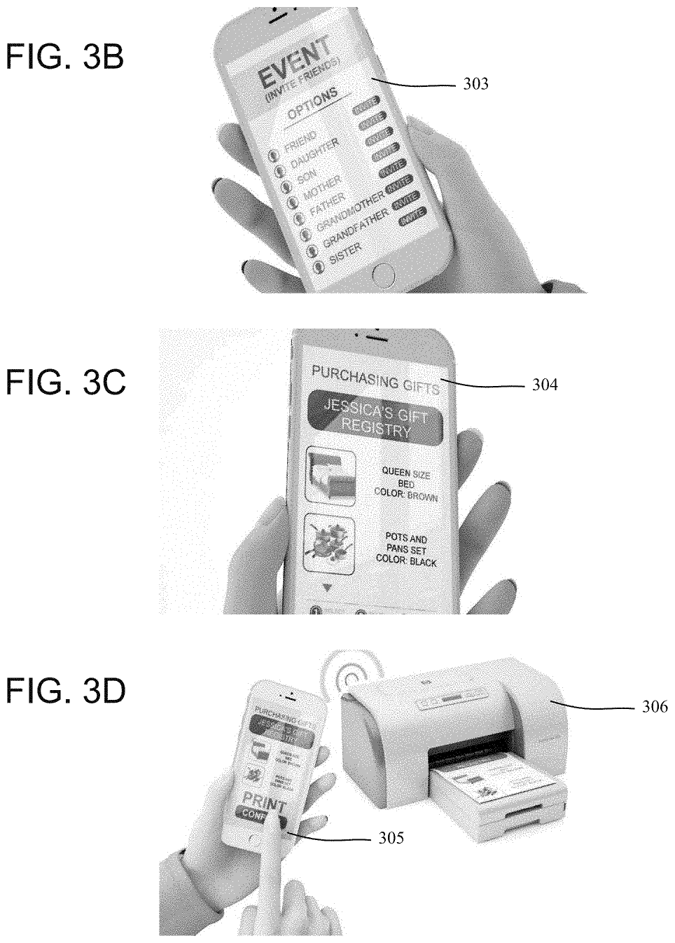

FIGS. 3A-D are exemplary screen shots of the gift registry application on a computing device according to an embodiment of the present invention. Referring now to FIG. 3A, an exemplary screen shot 302 of the application 100 is presented on a smart phone 301. In this embodiment, the exemplary screen shot 302 is a log in page to create a registry. FIG. 3B shows an exemplary screen shot of a user interface 303 enabling an event being created with the user enabling the optional step of inviting friends. FIG. 3C shows an exemplary screen shot of a user interface 304 enabling a user to purchase an item that has been added to the registry. Referring now to FIG. 3D, an exemplary screen shot of a user interface 305 enabling a user to print the registry list of items via a printer 306 is illustrated. It should be understood, that prior to printing, the printer needs to be connected to the smart phone via a wireless connection, such as Bluetooth, WiFi, or similar as well known in the art.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method for a gift registry comprising steps:
(a) providing an Internet-connected system having one or more Internet-connected servers executing a gift registry application software from non-transitory media, the gift registry application software enabling a user to log in and create the gift registry from a smartphone;
(b) an administer, via the gift registry application software, may be added, wherein the administer may create multiple accounts for additional users;
(c) adding a plurality of items, via the gift registry application software, to the gift registry, wherein each item of the plurality of items includes a link to enabling the purchase of each item, and, wherein if an item of the plurality of items is purchased the item would be marked as purchase preventing the item from being purchased again;
(d) creating an event, via the gift registry application software, wherein the additional users may be invented to the event; and,
(e) creating a monetary fund, via the gift registry application software, wherein the monetary fund enables at least the additional users to contribute currency to the monetary fund.

2. The method of claim 1, wherein the gift registry may be printed.
